(19) United States
(12) Patent Application Publication
(10) Pub. No.: US 2025/0125664 A1
(43) Pub. Date: Apr. 17, 2025

(54) Using Energy Detection to Identify Wireless Technology

(71) Applicant: TEXAS INSTRUMENTS INCORPORATED, Dallas, TX (US)

(72) Inventors: Kumaran Vijayasankar, Allen, TX (US); Farrukh Inam, Plano, TX (US)

(21) Appl. No.: 18/797,036

(22) Filed: Aug. 7, 2024

Related U.S. Application Data
(60) Provisional application No. 63/590,015, filed on Oct. 13, 2023.

(51) Int. Cl. H02J 50/80; H04W 4/80

(52) U.S. Cl. CPC H02J 50/80; H04W 4/80

(57) ABSTRACT

Systems and methods determine whether to switch to a second communication protocol from a first communication protocol based on energy detection. The energy detection may be used to indicate use of a channel defined by the second communication protocol. Energy detection on that channel may be accompanied by energy detection on an adjacent or close-by channel. If energy is detected on the channel and on an adjacent or a close-by channel, then that may indicate interference by a third communication protocol rather than by use of the channel on the second communication protocol. However, if energy is detected on the channel and not on the adjacent or close-by channel, then that may be an indication of use of the channel rather than interference.

### CROSS REFERENCE TO RELATED APPLICATIONS

The present application claims the benefit of U.S. Provisional Patent Application 63/590,015, filed Oct. 13, 2023, the disclosure of which is hereby incorporated herein by reference in its entirety.

### TECHNICAL FIELD

The present disclosure relates generally to an electronic system and method, and, in particular embodiments, to multi-protocol communication.

### BACKGROUND

Many wireless protocols exist for supporting applications of wireless sensor networks (WSN), and some devices use more than one wireless protocol. For example, a lighting network can use Zigbee for communication among the light devices in the network while allowing configuration, software updates, and diagnostics via a Bluetooth smart phone or tablet. Or a home automation system can use an IEEE 802.15.4-2015-based protocol to connect the devices in the system while supporting Bluetooth connectivity between one or more of the devices and a smart phone or tablet for configuration and monitoring.

### SUMMARY

Some embodiments relate to a device that operates in multiple protocols, e.g., sharing a same radio. By sharing the same radio, some embodiments may advantageously achieve lower area and cost.

In some embodiments, while a device is configured to operate according to a first protocol, the device uses energy detection for detecting the presence of packets of a second protocol. By using energy detection, some embodiments advantageously avoid the overhead of having to reconfigure the physical (PHY) layer to detect the second protocol.

In some embodiments, the device performs energy detection in a first channel where communication is expected, and in a second channel where communication is not expected but interference may be likely, and the device only reconfigures the PHY layer when energy is detected in the first channel and not in the second channel. By only reconfiguring the PHY layer when energy is detected in the first channel and not in the second channel, some embodiments advantageously reduce the overhead associated with reconfiguring the PHY layer when the energy detected in the first channel was due to interference and not because of the presence of packets expected.

In accordance to an embodiment, an electronic device including: a transceiver; and a processor configured to: receive signals via the transceiver; decode the signals according to a first communication protocol and on a first channel having a first center frequency and a first bandwidth; perform an energy detection operation on a second channel and on a third channel, where the second channel has a second center frequency and a second bandwidth, and where the third channel has a third center frequency and a third bandwidth; and determine that energy detected on the second channel corresponds to a second communication protocol based on the energy detection operation.

In accordance to an embodiment, an electronic device includes: a transceiver; and a processor configured to: receive signals via the transceiver; decode the signals according to a first communication protocol; perform an energy detection operation on a first channel and on a second channel, where the first channel has a first center frequency and a first bandwidth, and where the second channel has a second center frequency and a second bandwidth; and determine whether to change from decoding the signals according to the first communication protocol to decoding further signals received via the transceiver according to a second communication protocol based on results of the energy detection operation.

In accordance to an embodiment, a method includes: receiving and decoding signals according to a first communication protocol; generating a first energy measurement associated with a first channel of a second communication protocol; in response to the first energy measurement being above a first threshold, generating a second energy measurement associated with a second channel; subsequent to generating the second energy measurement, generating a third energy measurement associated with the first channel; and in response to the third energy measurement being below the first threshold, not generating a fourth energy measurement associated with the second channel.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is an illustration of an example computing device, which may be configured to support multiple communication protocols, according to various embodiments;

FIG. 2 is an illustration of the 2.4 GHz Wi-Fi frequency band, including its channelization, the use of which may be treated as interference in some embodiments;

FIG. 3 is an illustration of the frequency bands used by Bluetooth Low Energy (BLE) in some embodiments, and the computing device of FIG. 1 may support use of such frequency bands, according to some embodiments;

FIG. 4 is an illustration of operation of the computing device of FIG. 1, according to some embodiments;

FIG. 5 is an illustration of operation of the computing device of FIG. 1, according

to some embodiments;

FIG. 6 is an illustration of operation of the computing device of FIG. 1, according to some embodiments;

FIG. 7 is an illustration of operation of the computing device of FIG. 1, according to some embodiments;

FIG. 8 is an illustration of an example energy detection operation, which may be performed by the computing device of FIG. 1, according to some embodiments;

FIG. 9 is an illustration of an example method, for implementing multi-protocol timesharing, according to some embodiments; and

FIG. 10 is an illustration of an example method, for performing and analyzing energy detection operations, according to some embodiments.

Corresponding numerals and symbols in different figures generally refer to corresponding parts unless otherwise indicated. The figures are drawn to clearly illustrate the relevant aspects of the preferred embodiments and are not necessarily drawn to scale.

### DETAILED DESCRIPTION

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The present disclosure is not limited by the illustrated ordering of acts or events, as some acts may occur in different orders and/or concurrently with other acts or events. Furthermore, not all illustrated acts or events are required to implement a methodology in accordance with the present disclosure.

The description below illustrates various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” in this description indicate that a particular configuration, structure or feature described in relation to the embodiment is included in at least one embodiment. Consequently, phrases such as “in one embodiment” that may appear at different points of the present description do not necessarily refer exactly to the same embodiment. Furthermore, specific formations, structures or features may be combined in any appropriate manner in one or more embodiments.

In some applications, there may be a need for concurrent execution of more than one protocol on a wireless sensor device. However, concurrent execution of more than one protocol may experience complication in a noisy environment in which multiple protocols are operating. For instance, Bluetooth Low Energy (BLE) and Wi-Fi (IEEE 802.11) may have overlapping channels and may, thus, may be difficult to distinguish in some instances.

Embodiments of the present disclosure are described in specific contexts, e.g., a wireless device supporting an alternate communication protocol (e.g., BLE) with minimal impact to a primary communication protocol (e.g., an IEEE 802.15.4-based communication protocol, such as Zigbee or Thread) operating in the same frequency band and while minimizing false alarms. Some embodiments may use different primary and alternate (secondary) protocols. Some embodiments may use other standard or proprietary protocols, such as Bluetooth Classic, other protocols based on IEEE 802.15.4, and protocols not based on IEEE 802.15.4. Some embodiments may use protocols operating in the 2.4 GHz frequency band or in a frequency band different from 2.4 GHz, such as operating in the sub-1 GHz band, or in frequency bands above 2.4 GHz, such as 5 GHz, 6 GHZ, 7 GHZ, and 60 GHz. Some embodiments may use protocols operating in different frequency bands.

Many communication protocols may use a common or partially overlapping frequency band for their operation. For example Bluetooth Low Energy (BLE), Zigbee, Thread, and WiFi operate on the 2.4 GHz ISM band. Each protocol defines its own channelization, physical layer frame formats and other aspects of the network operation. It is common for a single device to be capable of supporting multiple protocols using a single physical radio. In cases in which a device supports communication on one protocol at a time (e.g., such as when multiple protocols share the same radio), the device may operate in one protocol for a given time period or may try to multiplex the radio to support multiple concurrent protocol operations.

In a device that supports communication on one protocol at a time, the associated receiver may detect packets belonging to only one of the protocol formats at a given time. Although different protocols may use the same frequency range, such protocols may still use different channels and modulation schemes. For example, BLE may use 40 channels with center frequencies between 2402 MHz and 2480 MHz, and Zigbee may use 16 channels with center frequencies between 2405 MHz and 2480 MHz. Typical systems tune their receivers for each of the protocol operation at respective channels and modulation schemes for each of the technologies in a time divided manner. This implies that some packets belonging to the technology at which a radio was not listening at that specific time may be lost.

In some applications, typical network operation is expected at one of the supported technologies (e.g., Zigbee or Thread) while an occasional support of another technology (e.g., BLE) may be required based on incoming packets from such another technology. For example. A device (e.g., a gateway device) may have a radio operating with IEEE 802.15.4 PHY used by technologies like Zigbee/Thread (that use an IEEE 802.15.4 PHY) for most of the time to support IoT devices. Occasionally a user may want to use a “BLE technology” to form a connection to the gateway device. Given the gateway device is primarily listening on the IEEE 802.15.4 physical layer (PHY) technology, it may not detect an incoming BLE packet. For the gateway device to receive such BLE packet, the gateway device may first switches its receiver to the BLE modulation scheme. The BLE packet may be received at any time, so the gateway device periodically switches to the BLE modulation scheme periodically and waits for a packet to be detected (e.g., by detecting the preamble and payload).

Periodically switching to the BLE modulation scheme may consume a substantial time, which is time that the gateway device is not operating according to the IEEE 802.15.4 PHY, which may affect the performance of the IEEE 802.15.4-based network. Such a loss in performance may not be desirable, especially when the activity on the other technology (e.g., BLE) is expected to be sporadic and minimal.

In some applications, it may be advantageous or even required to have a response time to an incoming packet in another technology (e.g., BLE) while maximizing the operating time in a primary technology (e.g., Zigbee or Thread).

Some embodiments minimize the number of times a PHY is changed (e.g., from an IEEE 802.15.4 modulation scheme to a BLE modulation scheme) until there is sufficient indication that a packet in the another technology (e.g., BLE) is incoming).

Some embodiments, while operating according to a first protocol (e.g., Zigbee or Thread) use energy detection in frequency bands of a second protocol (e.g., BLE) and exploit the known bandwidth of other possible interfering technologies (e.g., WiFi) to minimize false alarms. In some embodiments, minimizing false alarms advantageously allows for minimizing unnecessary switching from a first PHY (e.g., used by Zigbee or Thread) to a second PHY (e.g., used by BLE), thereby advantageously maximizing monitoring of the first protocol (e.g., Zigbee or Thread) without missing packets of the second protocol (e.g., BLE).

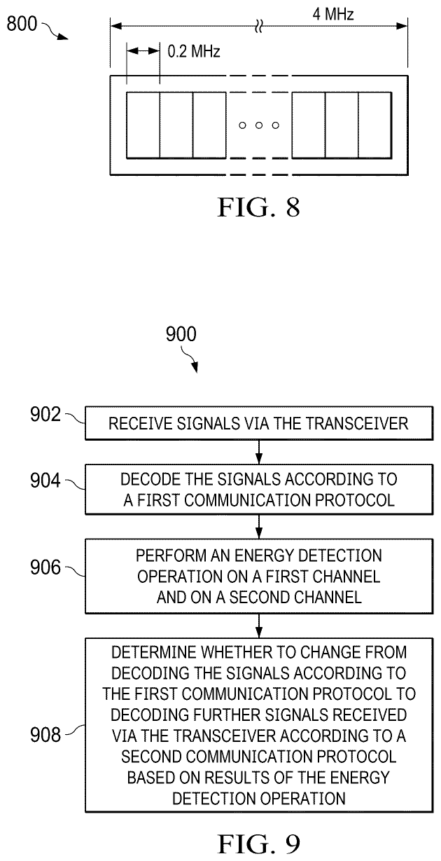

Energy detection may be understood as a process of detecting any increase in radio energy. Energy detection may be performed in particular frequency bands (ranges) and may be independent of the underlying wireless technology active in such frequency bands. Energy detection may be performed by monitoring the energy in a particular frequency range (e.g., by using digital and/or analog filters) without modifying the modem to switch to another communication protocol. When a frequency range has energy higher than a threshold, it may be determined to be busy, where the threshold may be predetermined or may be dynamic, e.g., based on a noise floor of the frequency range being monitored. A more detailed energy detection example, according to some embodiments, is described with respect to FIG. 8 below.

By switching to monitor energy associated with the second protocol (e.g., BLE) without modifying the modem to be able to process packets of the second protocol (e.g., BLE), some embodiments may advantageously reduce the switching time between the first and second protocols, thereby advantageously maximizing the time spent operating according to the first protocol or performing energy detection.

Some communication protocols, such as BLE, implement, e.g., sequential packet retransmission in multiple channels, (such as in BLE advertisement channels 37, then 38, then 39). Some embodiments may leverage such a feature to detect operation associated with such type of communication protocol while maximizing operation time in another communication protocol (e.g., Zigbee, Thread). While operating primarily according to a first protocol (e.g., Zigbee or Thread), some embodiments interrupt operation according to the first protocol and use energy detection (e.g., alone, e.g., without reconfiguring the modem to detect a preamble or packet associated with the second protocol, such as BLE) on an alternating technology channel (e.g., associated with BLE) to determine if there is a high probability of activity associated with the second protocol (e.g., BLE).

If it is determined that there is a high probability of activity in the alternating technology channel, the device configures the modem to receive packets in accordance with the second protocol (e.g., BLE) in a channel associated with the second protocol in which a retransmission of the packet is expected. For example, in an embodiment in which the device primarily operates according to Zigbee, and expects sporadic communication using BLE, a device may perform energy detection in channel 37 of BLE. Upon detection of energy in channel 37, the device can then monitor the channel where subsequent (in the time domain) retransmission would be expected according to such communication protocol (e.g., channel 38 and/or channel 39 of BLE). Upon detection of a packet in such channel where retransmission was expected (e.g., channel 38 or 39 of BLE), some embodiments continue operating in such protocol (e.g., BLE), e.g., to receive one or more, e.g., data packets. By using energy detection instead of attempting to detect a preamble, some embodiments may advantageously avoid the overhead of loading PHY configuration data to modify the modem of the device to receive packets associated with the second protocol (e.g., BLE).

By using energy detection instead of attempting to detect a preamble, some embodiments may advantageously detect communication even if the detection begins in the middle of a packet reception (since energy detected may still reflect that communication is taking place, even though a preamble of a packet may have only been partially captured by the receiver circuitry).

Although energy detection may be indicative of communication taking place in a particular frequency range, energy detection may not be able to distinguish between protocols operating (e.g., even partially), in such frequency range. For example, energy may be detected in the frequency range associated with channel 37 of BLE during WiFi communication, even if BLE communication is not taking place. Some embodiments advantageously reduce false alarms (e.g., reduce mistaking detection of WiFi communication for BLE communication), thereby advantageously avoiding unnecessarily reconfiguring the modem to listen for packets in the second protocol (e.g., BLE) that may not arrive.

A way to distinguish between protocols operating in a particular frequency range is to attempt to receive packets associated with protocols operating in such frequency range. For example, if energy is detected in the frequency range associated with channel 37 of BLE (having a center frequency of 2402 MHZ), and, at the same time, the device receives a packet in channel 1 of WiFi (having a frequency range from 2401 MHz to 2423 MHz), the probability that the energy is associated with BLE is low and the device may avoid switching the modem to monitor for BLE packets in channels 38 or 39.

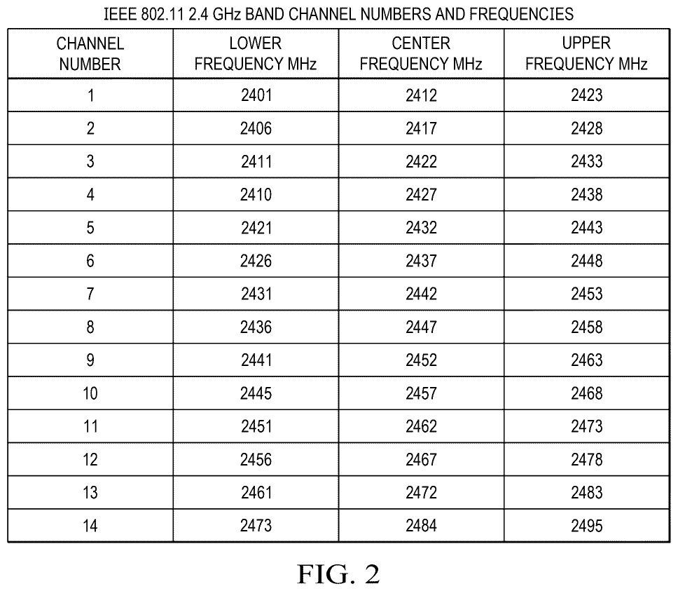

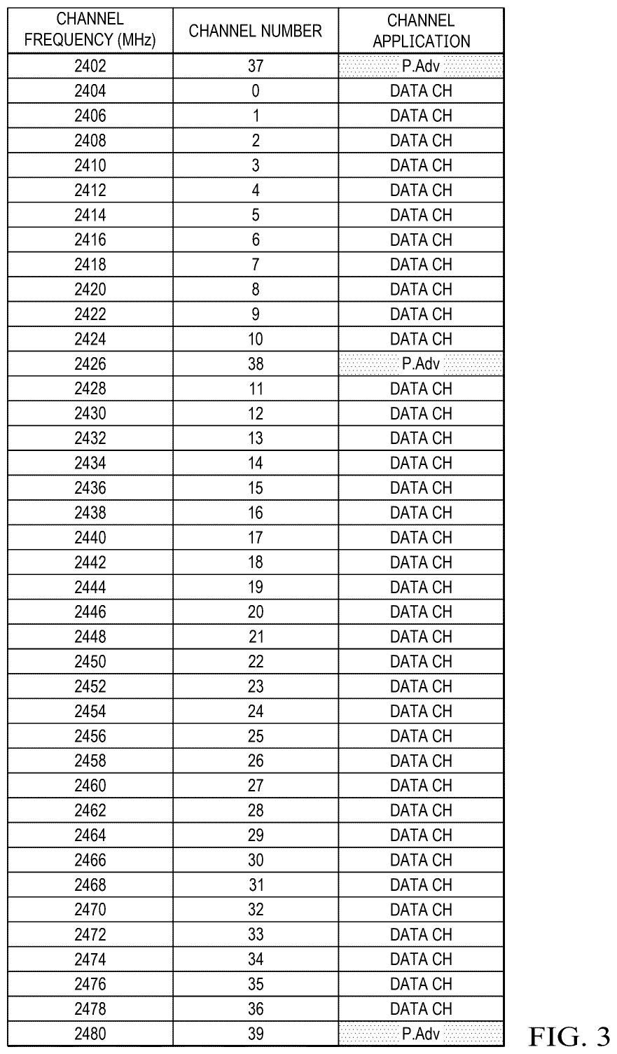

In some embodiments, the device may be unable to receive WiFi packets (e.g., either because the device does not support WiFi, or is unable to operate in WiFi at the time of energy detection). Some embodiments use the difference in the occupied channel bandwidth of different protocols (e.g., BLE and WiFi) and rely just on energy detection to distinguish between such protocols (e.g., between BLE and WiFi). For example, BLE uses a “2 MHz” channelization in the 2.4 GHz spectrum while “WiFi” uses 20 MHz channelization in the 2.4 GHz spectrum. This implies that:
during a WiFi transmission in a channel that overlaps with a BLE channel, more than 2 MHz of channel (e.g., frequencies adjacent to the BLE channel) may be sensed as busy (e.g., having energy above a predetermined threshold); and
during a BLE transmission in a channel that overlaps with a WiFi channel, only the bandwidth within the 2 MHz of the associated BLE channel may be detected as busy while the adjacent frequencies may be free. The Wifi and BLE channelization in 2.4 GHz spectrum is shown FIGS. 2 and 3, respectively.

In some embodiments, a device performs energy detection on a BLE channel (e.g., in the frequency range between 2401 MHz to 2403 MHz, associated with channel 37 of BLE) and then subsequently on the adjacent 2 MHz channels (e.g., in the frequency range between 2403 MHz to 2405 MHz, associated with channel 0 of BLE). In some embodiments, the device switches its radio to BLE and look for BLE activity only in the case when the targeted BLE channel (e.g., channel 37 of BLE) is busy and the adjacent channel (e.g., channel 0 of BLE) is free. After completing its operation with BLE technology or after a timeout, the device may resume operation according to the first protocol (e.g., IEEE 802.15.4-based protocol, such as Zigbee or Thread) by modifying the radio accordingly.

In some embodiments, the adjacent frequency range monitored for energy is a frequency range overlapping with a channel of the interfering technology. For example, some embodiments monitoring for energy in channel 37 of BLE may monitor the frequency range from 2403 MHz to 2405 MHz, overlapping with channel 0 of WiFi instead of monitoring the frequency 2309 MHz to 2410 MHz which does not overlap with any channel of WiFi. As another example, in some embodiments monitoring for energy in channel 38 of BLE (with frequency range between 2425 MHz to 2427 MHz) may monitor the frequency range from 2427 MHz to 2429 MHz, overlapping with channel 6 of WiFi instead of monitoring the frequency 2423 MHz to 2425 MHz which overlaps with channel 5 of WiFi (where channel 5 does not overlap with channel 38 of BLE).

Of course, the specific channels discussed herein are examples, and the scope of implementations may be adapted to different frequency ranges, different channels, and different protocols as appropriate.

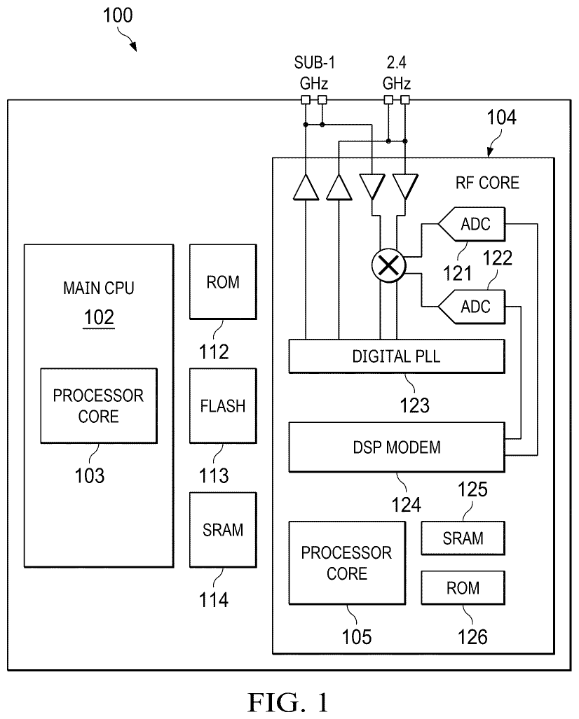

FIG. 1 is an illustration of an example computer system 100, which may be configured to support multiple communication protocols, according to various embodiments. In one example, computer system 100 may be implemented in a device, such as a sensor device, a smart phone, an automotive device, or the like. Furthermore, computer system 100 may be implemented on a single (e.g., monolithic) semiconductor die, and in another embodiment radio frequency (RF) core 104 and central processing unit (CPU) 102 may be implemented on separate semiconductor dies. In any event, RF core 104 and CPU 102 may be packaged in a same or a different semiconductor package as is appropriate for a particular application.

More specifically, the example computer system 100 may be implemented as a dual-band wireless microcontroller (MCU) and configured to allow concurrent execution of multiple protocols using a single multi-band radio. The computer system 100 incorporates main CPU 102 for executing applications and protocol software and includes processor core 103, though various embodiments may include multiple processor cores. The protocol software may include protocol stacks for the supported protocols, e.g., Thread, Zigbee, 6LoWPAN, Bluetooth/BLE, and/or proprietary protocols. Although not shown, the computer system 100 may include a multitude of peripherals and modules, such as a 12-bit ND converter, interfaces for SPI, Microwire, and UART protocols, internal direct memory access (DMA), a real-time clock, multiple 16/32-bit timers, and more. The computer system 100 may also include a sensor interface (not shown) that may incorporate a programmable sensor controller and peripherals for interfacing with analog or digital sensors.

The computer system 100 also includes RF core 104, which in this example, implements a dual-band sub-1 GHz and 2.4 GHz RF transceiver compatible with multiple protocols including the Bluetooth 5 low energy protocol and the IEEE 802.15.4 protocol. The RF core 104 is configured to autonomously handle time-critical aspects of transmitting and receiving various radio protocols. The RF core 104 includes a processor core 105 for executing software that, e.g., interfaces the analog RF and base-band circuitry, handles data transmission to and from the main CPU 102, and assembles packets for transmission based on the particular protocol corresponding to the packets. The software may include a command-based application program interface (API) used by applications executing on the main CPU 102 to communicate with the RF core 104.

The RF core includes analog-to-digital converters (ADCs) 121 and 122 for in-phase and quadrature digital signals. The digital phase locked loop (PLL) 123 may provide a clock for use by the various internal components of RF core 104. The digital signal processor (DSP) modem 124 may receive the in-phase and quadrature signals and provide modulation and demodulation for the signals transmitted and received by the RF core 104. Processor core 105 may provide control for the RF core 104. Processor core 105 may use static random access memory (SRAM) 125 as a system memory, and it may execute code stored at the read-only memory (ROM) 126.

The computer system 100 also incorporates flash memory 113 that provides nonvolatile storage for code and data, static random access memory (SRAM) 114 that can be used for both storage of data and execution of code, and a read-only memory (ROM) 112 storing a real-time operating system kernel. Software instructions implementing methods as described herein can be stored in a computer readable medium on the computer system 100 such as the flash memory 113, the static random access memory (SRAM) 114, or the read-only memory (ROM) 112 and executed by the main CPU 102.

A dynamic multi-protocol manager (DMM) application executing on the main CPU 102 may provide time shared access to the radio resources of RF core 104 for radio commands issued by multiple protocol stacks. The DMM application may be configured to handle dynamic switching of the RF core 104 between radio commands issued by the protocol stacks based on scheduling policies and run-time stack states. In general, the DMM application may receive radio commands from the protocol stacks and may insert the commands into a command queue based on scheduling policies associated with the current states of the stacks and timing information specified in command parameters. The DMM application may also dispatch commands from a command queue of CPU 102 to the RF core 104.

In one example, the modem 124 may provide energy detection for a multitude of different channels. For instance, the modem 124 may receive the digital in-phase and quadrature signals from the ADCs 121, 122, and it may process those digital signals to determine energy levels associated with different channels. As noted above, channels may be defined by a particular protocol, and each channel may include a respective center frequency and a bandwidth.

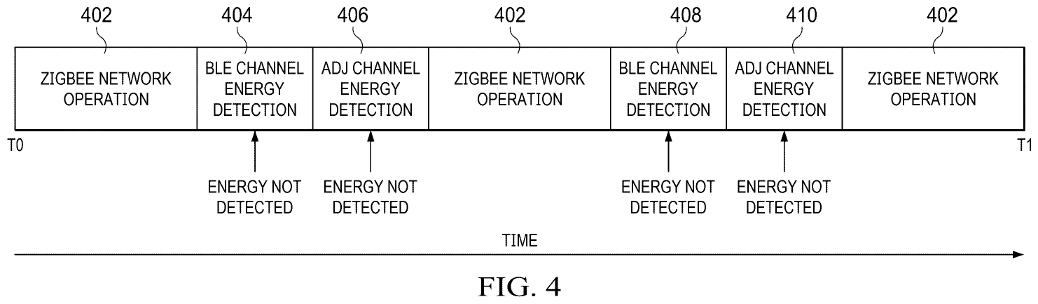

The modem 124 may transmit the energy detection results to main CPU 102, which implements the wireless protocol stacks. The main CPU 102 may execute computer-readable code to perform the multi-protocol operation. For instance, the main CPU 102 may receive energy detection results for the multiple channels and then take action in response to the energy detection results. Energy detection results and the actions that may be taken by the main CPU 102 are described in more detail with respect to FIGS. 4-10.

Computer system 100 may be configured to operate using multiple different communication protocols. In one example, computer system 100 is configured to operate according to an IEEE 802.15.4-based communication protocol and in another protocol, such as BLE. However, the computer system 100 may operate in a crowded RF environment, such that computer system 100 may receive or be exposed to energy from, e.g., an IEEE 802.11 protocol (e.g., even if computer system 100 is not capable of processing packets of such protocol).

FIG. 2 is an illustration of the 2.4 GHz Wi-Fi frequency band, including its channelization, the use of which may be treated as interference in some embodiments. The 2.4 GHz band is 100 MHz wide, spanning from 2400 MHz to 2500 MHz. In the 2.4 GHz Wi-Fi frequency band, there are 14 channels designated. These channels are spaced 5 MHz apart from each other, except for a 12 MHz space before channel 14. Channels 1, 6, and 11 are the most commonly used Wi-Fi channels because they allow for minimal overlap in Wi-Fi signals. Channel 1 has a center frequency at 2412 MHz. Channel 6 has a center frequency at 2437 MHz. Channel 11 has a center frequency at 2462 MHz.

FIG. 3 is an illustration of the frequency bands used by BLE in some embodiments. BLE operates in the 2.4 GHz band and divides the band into 40 different channels. The channels are spaced 1 MHz apart. The channels 37, 38, and 39 are referred to as the advertising channels. The channels 0-36 are referred to as the data channels. The data channels are used for data exchange once a connection has been established between BLE devices.

Note that channel 1 of Wi-Fi spans from 2401 MHz to 2423 MHz. Therefore, channel 1 of Wi-Fi overlaps with BLE channels 37 and 0-9. Although the scope of implementations is not limited to any particular frequency range, channel, or protocol, the examples of FIGS. 4-9 describe the RF context of a device (e.g., computer system 100) configured to operate according to multiple communication protocols in the 2.4 GHz industrial, scientific, and medical (ISM) band.

FIG. 4 is an illustration of operation of computer system 100 of FIG. 1, according to some embodiments. In the example of FIG. 4, computer system 100 is configured to operate according to a first protocol (e.g., Zigbee) and to switch operation between the first protocol and a second protocol (e.g., BLE). The passage of time is marked from left to right.

In the example of FIG. 4, the Zigbee network operation 402 is performed from time T0 at least through time T1 (except for possibly interrupting Zigbee network operation for energy detection, in some embodiments). In some embodiments, the computer system 100 interrupts Zigbee network operations to perform energy detections (e.g., 404, 406, 408, and 410). In some embodiments, the computer system 100 does not interrupt Zigbee network operations to perform energy detections (e.g., the energy detections are performed in parallel).

Performing the Zigbee network operation 402 may include receiving and decoding Zigbee packets as well as encoding and transmitting Zigbee packets. During operation, the computer system 100 performs a first energy detection operation 404 on a first BLE channel and a second energy detection operation 406 on a second BLE channel. For instance, energy detection operation 404 may detect energy on BLE channel 37, and energy detection operation 406 may detect energy on BLE channel 0. The computer system 100 does not detect energy according to the energy detection operations 404 and 406. This may indicate that the BLE channels are not in use and may also indicate that there is not interference overlapping those BLE channels by, e.g., Wi-Fi.

Energy detection operations 408 and 410 are performed similarly to energy detection operations 404 and 406. Once again, in the example illustrated in FIG. 4, computer system 100 does not detect energy according to either of the energy detection operations 408 and 410.

Since the BLE channel in this example, channel 37, is not busy, the computer system 100 determines not to change from decoding signals according to Zigbee. Of note in this example is that the energy detection operations 404, 406, 408, 410 do not require the computer system 100 to switch from decoding Zigbee, so that, in some embodiments, the Zigbee network operation 402 may be uninterrupted in FIG. 4. In embodiments that interrupt Zigbee network operations for performing energy detection, such interruption may not involve reconfiguring the PHY, and as such, may not incur the overhead of reconfiguring the PHY.

The computer system 100 may continue to periodically perform further energy detection operations (not shown).

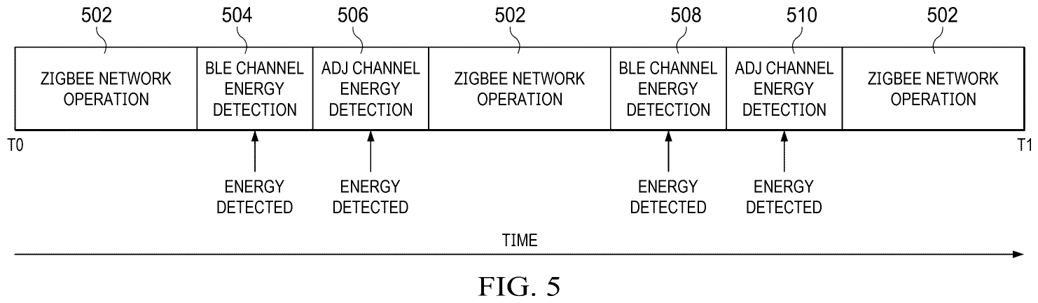

FIG. 5 is an illustration of operation of computer system 100 of FIG. 1, according to some embodiments. The computer system 100 is configured to perform Zigbee operation 502, which may be the same as or similar to Zigbee operation 402 of FIG. 4.

Energy detection operation 504 may be performed to detect energy on a BLE channel, such as BLE channel 37. Energy detection operation 506 may be performed to detect energy on another BLE channel, such as an adjacent channel (Channel 0) or another channel (e.g., any of channels 1-9) that may be expected to overlap with Wi-Fi channel 1.

In the example of FIG. 5, energy detection operation 504 detects energy, which may be an indication of BLE activity on channel 37. Further, energy detection operation 506 detects energy, which may be an indication that the energy is a result of an interfering communication protocol (e.g., Wi-Fi) rather than the desired protocol (e.g., BLE). As a result, computer system 100 determines that BLE channel 37 is not in use and further determines not to switch from Zigbee to BLE.

The energy detection operations 508 and 510 are performed in the same way as energy detection operations 504 and 506. Since energy detection operations 508 and 510 indicate that Wi-Fi interference is more likely than BLE use, the computer system 100 maintains the Zigbee network operation 502 from time T0 at least through time T1. The computer system 100 may continue to periodically perform further energy detection operations (not shown).

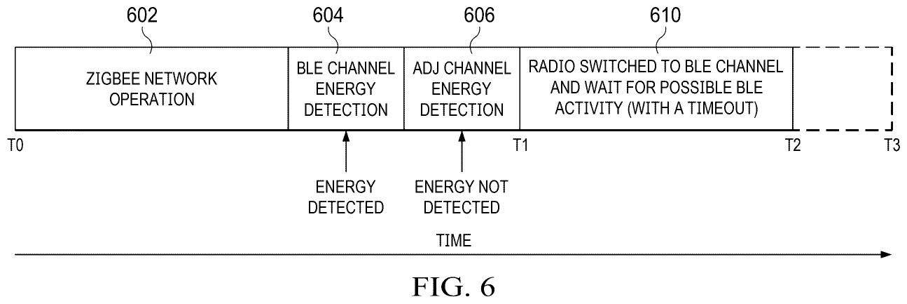

FIG. 6 is an illustration of operation of computer system 100 of FIG. 1, according to some embodiments. Zigbee operation 602 may include receiving and decoding Zigbee packets as well as encoding and transmitting Zigbee packets. At time T0, computer system 100 performs Zigbee network operation 602. Subsequent to time T0, computer system 100 performs energy detection operation 604, which detects energy. Energy detection operation 604 indicates that the particular BLE channel (e.g., channel 37) is likely to be in use. Energy detection operation 606 does not detect energy, which is a further indication that BLE channel 37 is likely to be in use. Computer system 100 is configured to use such confirmation as a factor in switching from one communication protocol to the other.

Therefore, computer system 100 in this example determines to change from decoding the signals according to the first communication protocol (Zigbee) to decoding further signals received according to the second communication protocol (BLE), such as at BLE operation 610. At time T1, computer system 100 causes RF core 104 to switch from Zigbee to BLE. The switch may include reconfiguring the system from one physical layer (PHY) in the protocol stack for Zigbee to another PHY in the protocol stack for BLE. The switch may also include tuning from one center frequency within the band to another center frequency within the band. As a result, the computer system 100 may stop receiving and decoding Zigbee signals and instead begin receiving and decoding BLE signals.

As shown in FIG. 6, in such scenario, the computer system 100 may switch RF core 104 to BLE and monitors for incoming BLE packets (e.g., in another channel, such as 38 or 39 of BLE) at BLE operation 610. If BLE packets arrive within a timeout, the computer system 100 may continue operating in BLE for a period of time (e.g., beyond T2 to a time T3 not shown), including receiving and decoding packets in a BLE data channel (e.g., one or more of channels 0 to 36), establishing a connection for data transmission and reception, and disconnecting. At the end of the BLE period (e.g., at time T2 or T3, depending on whether BLE communication was performed), the computer system 100 returns to the first protocol operation (e.g., Zigbee). For example, if the timeout expires without receiving any packets, the computer system 100 may return to the first protocol operation (e.g., Zigbee) at time T2. If BLE packets are received by computer system 100 before time T2, then, the computer system 100 may return to the first protocol operation at time T3.

In some embodiments, energy detection operations for the BLE channel and for the adjacent channel takes between 400 μs and 500 μs each, while operation in the first protocol (e.g., Zigbee) may take between 7 ms and 9 ms (with the transition time to monitor energy from Zigbee or vice versa taking negligible time). In some embodiments, switching the radio from Zigbee to BLE takes about 400 μs. Of course, those are just examples, and the scope of implementations is not limited to any particular times.

As noted above, at time T2 or T3, the computer device 100 may return to Zigbee operation and may perform further energy detection operations periodically.

In some embodiments, the operations illustrated in FIGS. 4 to 6 may all be performed by the same computer system 100 at different times, e.g., depending on the results on the energy detection.

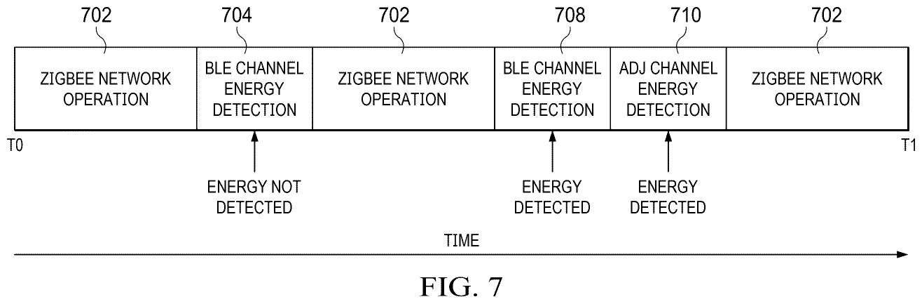

FIG. 7 is an illustration of operation of computer system 100, according to some embodiments. As in the examples of FIGS. 4 and 5, the Zigbee operation 702 is uninterrupted from time T0 to time T1.

Zigbee operation 702 may include receiving and decoding Zigbee packets as well as encoding and transmitting Zigbee packets. After some period of time, the computer system 100 performs energy detection operation 704. Energy detection operation 704 does not detect energy on the particular channel (e.g., BLE channel 37), which is an indication that the particular BLE channel is not in use. Computer system 100 uses the negative result of energy detection operation 704 to determine not to analyze a further BLE channel. In this example, a negative result of energy detection operation 704 is treated as conclusive as to whether the particular BLE channel is in use. For instance, computer system 100 may determine not to perform an energy detection operation on an adjacent or close-by channel. In another example, the energy detection operation 704 is performed over a bandwidth wide enough to cover an adjacent channel, and computer system 100 may not analyze the results from the adjacent channel.

Subsequently, the computer system 100 performs energy detection operation 708, which detects energy. Based on the positive results of energy detection operation 708, the computer system 100 determines to perform energy detection operation 710 on an adjacent or close-by channel. Specifically, a positive result of energy detection operation 708 may be treated as an indication that the particular BLE channel is in use so that interfering energy from a third communication protocol (Wi-Fi) should be ruled out. Computer system 100 uses energy detection operation 710 to rule out BLE. Specifically, the positive results of energy detection operation 710 indicates that the results of energy detection operation 708 results be associated with interfering energy rather than from BLE channel use.

The computer system 100 may treat the results of the energy detection operations 708 and 710 similarly to how the computer system 100 treats the results of the energy detection operations 504 and 506 of FIG. 5. The computer system 100 uses the positive results of energy detection operation 708 and 710 to determine not to switch from Zigbee to BLE. The computer system 100 may continue to periodically perform further energy detection operations (not shown).

The operations in FIGS. 4-7 are not mutually exclusive. Rather, the computer system 100 may primarily use the first communication protocol (e.g., Zigbee) and periodically check for channel use of a second communication protocol (e.g., BLE). As the computer system operates over a relatively long stretch of time, it may select actions based on the results of the periodic energy detection operations. In other words, the actions shown in FIG. 4 may be performed before or after actions shown in any one or all of FIGS. 5-7. The same is true of any one or all of the FIGS. 5-7 and FIG. 4.

Furthermore, the scope of implementations is not limited to only two energy detection operations at a given point. For instance, determining whether an interfering technology (e.g., WiFi) is producing the energy that is detected in the channel of the target technology (e.g., BLE) may be based on the frequency ranges adjacent to both channels of the monitored channel (e.g., determining that the channel is busy as a result of an interfering technology only if the frequency ranges adjacent to both sides of the energy monitored channel are also busy).

Also, while energy detection operations in FIGS. 4-7 (e.g., energy detection operations 404 and 406) are shown as being sequential, the scope of implementations is not so limited. Rather, energy detection operations (e.g., energy detection operations 404 and 406) may be performed in parallel, as discussed below with respect to FIG. 8.

In some embodiments, energy detection in both the BLE channel and the adjacent or close-by channel(s) may be performed simultaneously (e.g., by using analog and/or digital filters). For example, in some embodiments capable of detecting energy over a larger bandwidth at the same time while still being able to get distinct samples with smaller sections, such an energy detection mechanism may be used instead of two separate energy detections done close to each other, to further improve performance.

FIG. 8 is an illustration of an example energy detection operation 800, according to one embodiment. Energy detection operation 800 illustrates a technique that may be used in the various energy detection operations described with respect to FIGS. 4-10.

As shown in FIG. 8, in some embodiments, the computer system 100 may be configured to perform energy detection over a 4 MHz channel with samples being obtained every 0.2 MHz. The computer system 100 may then generate, e.g., about 20 samples taken for a same period of time. Using the values of individual samples, the computer system 100 may determine whether only a portion of the samples show activity or whether all of the samples show activity. If only a portion of the samples show energy and the bandwidth matches close to that of the monitored BLE channel (e.g., 37), then it may be determined with more confidence that there is BLE activity and not WiFi activity. In such an instance, the computer system 100 may proceed to switching the RF core 104 to BLE to scan for BLE packets.

The computer system 100 may use an energy detection operation, such as energy detection operation 800, to determine whether energy is detected. For instance, looking at energy detection operations 704 and 708 of FIG. 7, they show “energy not detected” and “energy detected,” respectively. Energy detection operation 704 examines a bandwidth corresponding to BLE channel 37, as does energy detection operation 708. A higher level of energy within that bandwidth may lead to greater confidence that energy is detected, whereas a lower level of energy within that bandwidth may lead to greater confidence that energy is not detected. Computer system 100 may be configured with thresholds to set for “energy not detected” and “energy detected.” The results of energy detection operations 704 and 708 may be based on those thresholds in some examples.

Similarly, energy detection operation 710 may look at a bandwidth corresponding to another BLE channel, such as any of 0-9. In one example, energy detection operation 708 and energy detection operation 710 may be performed over a same bandwidth, such as 4 MHz, as shown in energy detection operation 800. In another embodiment, such as when the adjacent or close-by channel cannot be accommodated within a same energy detection bandwidth, then multiple energy detection operations 800 may be used as appropriate. Furthermore, the same or similar thresholds may be used to determine whether energy is detected or energy is not detected.

In some instances, the energy detection operation 800 may be an energy detection operation that is used for received signal strength indicator (RSSI) measurements. For instance, some wireless systems may use RSSI measurements for determining channel quality, among other things. In the examples of FIGS. 4-10, the energy detection operations may include RSSI measurements that may be used to determine whether a BLE channel is busy.

As noted above, in one example, the modem 124 of the RF core 104 may be configured to perform energy detection operations and to transmit the results to the main CPU 102. Furthermore, the main CPU 102 may be configured to include one or more algorithms to determine whether energy is present or not present for a particular energy measurement, whether to perform another energy detection operation on another channel based on the results of the first energy detection operation, whether to switch from one communication protocol to another based on energy detection results, and the like. Nevertheless, the scope of implementations is not limited to any particular component of FIG. 1 performing any particular function. Rather, the energy detection operations may be performed by any appropriate component of computer system 100, and analysis of the results and decision-making based on the results of the energy detection operations may also be performed by any appropriate component of computer system 100.

FIG. 9 is an illustration of example method 900, for implementing multi-protocol timesharing, according to various embodiments. For example, computer system 100 may perform method 900. More specifically, computer system 100 may include hardware logic, firmware functionality, and/or software functionality to perform the actions of method 900.

At action 902, the computer system 100 may receive signals via its transceiver. For instance, RF core 104 may receive signals via antennas.

At action 904, the computer system 100 may decode the signals according to a first communication protocol. For instance, a component in the RF core 104, such as the modem 124, may be configured to decode the received signals according to a first communication protocol. In one example, the first communication protocol may include an IEEE 802.15.4-based communication protocol, such as Zigbee or Thread. The first communication protocol may define a plurality of channels, each of the channels having a center frequency and a bandwidth, and the first signal may be received on one or more of those channels.

In the examples above, Zigbee network operations 402, 502, 602, and 702 may include receiving and decoding signals via a first communication protocol.

At action 906, the computer system 100 may perform an energy detection operation on a first channel and on a second channel. The first channel and the second channel may be defined according to a second communication protocol, which is different from the first communication protocol. Furthermore, the first channel and the second channel may be defined by the second communication protocol to have respective center frequencies and bandwidths. Furthermore, the first and second channel may be different from any of the plurality of channels defined by the first communication protocol.

Examples of energy detection operations are shown and discussed above. For instance, example energy detection operations on the first channel may correspond to energy detection operations 404, 408, 504, 508, 604, 704, and 708. In those examples, the energy detection operation on the first channel may correspond to an advertising channel, such as BLE channel 37.

Furthermore, the energy detection operation on the second channel may correspond to example energy detection operations 406, 410, 506, 510, 606, and 710. The energy detection operation on the first channel and the energy detection operation on the second channel may be performed sequentially or in parallel and may be performed as described above with respect to FIG. 8. The second channel may be adjacent to the first channel or may be separated by some quantity of channels from the first channel. For instance, the second channel may include any one of BLE channels 0-9.

At action 908, the computer system 100 determines whether to change from decoding the signals according to the first communication protocol to decoding further signals received via the transceiver according to the second communication protocol. The computer system 100 may make the determination based on results of the energy detection operations of action 906. Action 908 may include determining whether energy detected on the first channel corresponds to the second communication protocol.

In the example of FIG. 4, both of the energy detection operations 404, 406 result in no energy detected. That may be an indication that the first channel of the second communication protocol is unused. Therefore, the computer system 100 may determine not to change from the first communication protocol to the second communication protocol.

In the example of FIG. 5, the energy detection operations 504, 506 both result in detecting energy. Computer system 100 may be configured to interpret such results as energy from an interfering third protocol rather than from the second communication protocol. Specifically, in one example, energy adjacent to the first channel may be taken as an indicator of Wi-Fi interference rather than use of the first channel. Therefore, the computer system 100 may determine not to change from the first communication protocol to the second communication protocol.

In the example of FIG. 6, energy detection operation 604 results in energy detected, and energy detection operation 606 results in energy not detected. The computer system 100 may be configured to interpret such results as energy corresponding to the second communication protocol. Therefore, the computer system 100 may determine to change from the first communication protocol to the second communication protocol. In one example, the computer system 100 uses the results of energy detection operations 604 and 606 to determine that BLE channel 37 is in use. Based on that determination, the computer system 100 may then switch to BLE channel 38 or BLE channel 39 to receive and decode a subsequent in time advertisement, such as described above with respect to BLE operation 610.

Computer system 100 may continue to perform method 900 over and over, according to a set period. Subsequent performance of method 900 may result in either switching from the first communication protocol to the second communication protocol or not switching from the first communication protocol to the second communication protocol based on the results of the energy detection operations and as appropriate. Should computer system 100 switch from the first communication protocol to the second communication protocol, computer system 100 may after some time switch from the second communication protocol back to the first communication protocol.

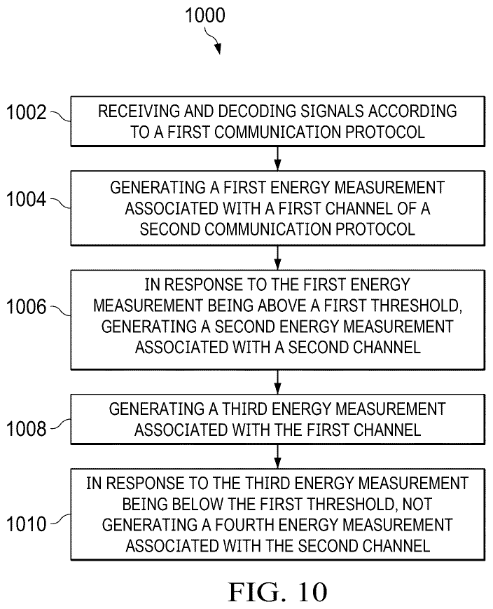

FIG. 10 is an illustration of example method 1000, for performing and analyzing energy detection operations, according to various embodiments. Method 1000 may be performed by a computer system, such as computer system 100 of FIG. 1.

At action 1002, the computer system 100 may receive and decodes signals according to a first communication protocol. An example is shown at Zigbee network operation 702 of FIG. 7.

At action 1004, the computer system 100 may generate a first energy measurement associated with a first channel of a second communication protocol. An example is shown at energy measurement operation 708.

At action 1006, the computer system 100 may determine to generate a second energy measurement associated with a second channel in response to the energy measurement of action 1004 being above a first threshold. For example, the computer system 100 may interpret the results of energy detection operation 708 as being positive (e.g., above the first threshold), which may be an indication that a BLE advertising channel is in use. The computer system 100 may be configured to then determine whether the energy corresponds to the second communication protocol (e.g., BLE) or to an interfering third protocol (e.g., Wi-Fi). Therefore, the computer system 100 may perform energy detection operation 710. Based on the results of the energy detection operation of action 1006, the computer system 100 may continue to operate in the first communication protocol or may switch the radio to operate in the second communication protocol.

Various embodiments may perform energy detections periodically while operating in the first communication protocol. In other words, after some amount of time, the computer system 100 may begin the energy detection process again by performing a subsequent energy measurement with respect to the first channel of the second communication protocol.

Thus, at action 1008, the computer system 100 may generate a third energy measurement, which is associated with the first channel. Put another way, the computer system 100 may, subsequent to action 1006, perform energy measurement operation 708 again. Action 1008 may be separated from action 1002 by a set period. For instance, the computer system 100 may be configured to perform the energy detection operations periodically.

At action 1010, the computer system 100 may determine not to generate a fourth energy measurement associated with the second channel based on the results of the energy measurement of action 1008. For instance, action 1008 may correspond to energy detection operation 704. Based on negative results (e.g., below the first threshold), the computer system 100 may determine not to perform or analyze energy detection for an adjacent or close-by channel. Specifically, the computer system 100 may be configured to interpret the negative results of the energy detection operation of action 1008 as being conclusive that the first channel of the second communication protocol is unused, regardless of any other energy detections.

Of note here is that, while performing energy detections periodically, computer system 100 may interpret the results of the energy detection operation 708 as positive and then, at a later time, perform another energy detection operation and then interpret the results of that energy detection operation as negative. The computer system 100 may continue to perform those energy detections based on the set periods, interpreting the results as appropriate. Furthermore, although not shown, energy detections tending to show use of the second communication protocol may result in switching from the first communication protocol to the second communication protocol, such as described above with respect to FIG. 6.

Example embodiments of the present disclosure are summarized here. Other embodiments can also be understood from the entirety of the specification and the claims filed herein.

Example 1. An electronic device including: a transceiver; and a processor configured to: receive signals via the transceiver; decode the signals according to a first communication protocol and on a first channel having a first center frequency and a first bandwidth; perform an energy detection operation on a second channel and on a third channel, where the second channel has a second center frequency and a second bandwidth, and where the third channel has a third center frequency and a third bandwidth; and determine that energy detected on the second channel corresponds to a second communication protocol based on the energy detection operation.

Example 2. The electronic device of example 1, where the processor is configured to determine that the energy detected on the second channel corresponds to the second communication protocol by determining that the energy detected on the second channel is above a first threshold and by determining that energy detected on the third channel is below a second threshold.

Example 3. The electronic device of one of examples 1 or 2, where the second channel corresponds to a first advertising channel, and where the third channel corresponds to a first data channel.

Example 4. The electronic device of one of examples 1 to 3, where the processor is further configured to, in response to determining that energy detected on the second channel corresponds to the second communication protocol: stop decoding the signals according to the first communication protocol; receive, via the transceiver, further signals on a fourth channel that is associated with the second communication protocol, where the fourth channel has a fourth center frequency and a fourth bandwidth; and decode the further signals according to the second communication protocol.

Example 5. The electronic device of one of examples 1 to 4, where the fourth bandwidth and the second bandwidth are equal, and where the second center frequency and the fourth center frequency are different.

Example 6. The electronic device of one of examples 1 to 5, where the processor is further configured to, in response to determining that energy detected on the second channel corresponds to the second communication protocol: stop decoding the signals according to the first communication protocol; and reconfigure a physical layer of the transceiver to receive and decode further signals on a fourth channel having a fourth center frequency and a fourth bandwidth.

Example 7. The electronic device of one of examples 1 to 6, where the processor is further configured to, in response to determining that energy detected on the second channel corresponds to the second communication protocol: stop decoding the signals according to the first communication protocol; and receive, via the transceiver, and decode further signals according to a third communication protocol and on a fourth channel that partially or fully overlaps with the third channel.

Example 8. The electronic device of one of examples 1 to 7, where the fourth channel has a fourth bandwidth that is bigger than the third bandwidth.

Example 9. The electronic device of one of examples 1 to 8, where the second channel corresponds to Bluetooth Low Energy (BLE) channel 37, and where the third channel corresponds to BLE channel 0.

Example 10. The electronic device of one of examples 1 to 9, where the third channel is overlapped by Wi-Fi channel 1.

Example 11. The electronic device of one of examples 1 to 10, where to perform the energy detection operation, the processor is configured to generate a received signal strength indicator (RSSI) for the second channel and the third channel.

Example 12. The electronic device of one of examples 1 to 11, where the processor is configured to determine that the energy detected on the second channel corresponds to the second communication protocol by determining that the RSSI for the second channel is above a first threshold and by determining that the RSSI for the third channel is below a second threshold.

Example 13. The electronic device of one of examples 1 to 12, where the second channel and the third channel do not overlap.

Example 14. The electronic device of one of examples 1 to 13, where to determine that energy detected on the second channel corresponds to a second communication protocol, the processor is configured to determine that a fourth channel, associated with a third communication protocol and that overlaps with the third channel, is not busy with further signals associated with the third communication protocol.

Example 15. The electronic device of one of examples 1 to 14, where the second channel and the third channel are adjacent according to the second communication protocol.

Example 16. The electronic device of one of examples 1 to 15, where the second channel and the third channel are separated by at least one further channel according to the second communication protocol.

Example 17. The electronic device of one of examples 1 to 16, where the second bandwidth and the third bandwidth are equal, and where the second center frequency and the third center frequency are different.

Example 18. The electronic device of one of examples 1 to 17, where the first communication protocol is an IEEE 802.15.4-based communication protocol.

Example 19. The electronic device of one of examples 1 to 18, where the first communication protocol is a Zigbee protocol and the second communication protocol is a Bluetooth Low Energy (BLE) protocol.

Example 20. The electronic device of one of examples 1 to 19, where the processor is configured to perform the energy detection operation on the second channel, and the energy detection operation on the third channel, sequentially.

Example 21. The electronic device of one of examples 1 to 20, where the processor is configured to perform the energy detection operation on the second channel, and the energy detection operation on the third channel, in parallel.

Example 22. An electronic device including: a transceiver; and a processor configured to: receive signals via the transceiver; decode the signals according to a first communication protocol; perform an energy detection operation on a first channel and on a second channel, where the first channel has a first center frequency and a first bandwidth, and where the second channel has a second center frequency and a second bandwidth; and determine whether to change from decoding the signals according to the first communication protocol to decoding further signals received via the transceiver according to a second communication protocol based on results of the energy detection operation.

Example 23. The electronic device of example 22, further including: an antenna coupled to the transceiver and configured to receive the signals over the air.

Example 24. The electronic device of one of examples 22 or 23, where to perform the energy detection operation, the processor is configured to detect energy above a first threshold on the first channel and detect energy below a second threshold on the second channel.

Example 25. The electronic device of one of examples 22 to 24, where the processor is configured to determine to change to decoding the further signals according to the second communication protocol based on detecting energy above the first threshold on the first channel and detecting energy below the second threshold on the second channel.

Example 26. The electronic device of one of examples 22 to 25, where the processor is configured to determine to not change to decoding the further signals according to the second communication protocol based on detecting energy above a first threshold on the first channel and detecting energy above a second threshold on the second channel.

Example 27. The electronic device of one of examples 22 to 26, where the processor is further configured to: end decoding the signals according to the first communication protocol; and begin decoding the further signals according to the second communication protocol in response to determining to change to decoding the further signals.

Example 28. The electronic device of one of examples 22 to 27, where to perform the energy detection operation on the first channel, the processor is configured to monitor a first advertising channel for energy associated with an advertising packet, and where to begin decoding the further signals the processor is configured to receive and decode a second advertising packet on a second advertising channel.

Example 29. The electronic device of one of examples 22 to 28, where the processor is further configured to: end decoding the signals according to the first communication protocol; and reconfigure a physical layer of the transceiver to decode the further signals according to the second communication protocol in response to determining to change to decoding the further signals.

Example 30. The electronic device of one of examples 22 to 29, where the electronic device is a sensor.

Example 31. A method including: receiving and decoding signals according to a first communication protocol; generating a first energy measurement associated with a first channel of a second communication protocol; in response to the first energy measurement being above a first threshold, generating a second energy measurement associated with a second channel; subsequent to generating the second energy measurement, generating a third energy measurement associated with the first channel; and in response to the third energy measurement being below the first threshold, not generating a fourth energy measurement associated with the second channel.

Example 32. The method of example 31, where receiving the signals includes receiving the signals via a transceiver, the method further including, in response to determining that the second energy measurement is below a second threshold, tuning the transceiver to a third channel, associated with the second communication protocol.

Example 33. The method of one of examples 31 or 32, where the first channel corresponds to channel 37 of a Bluetooth Low Energy (BLE) protocol, and where the third channel corresponds to channel 38 or 39 of the BLE protocol.

Example 34. The method of one of examples 31 to 33, where the first channel and the third channel correspond to Bluetooth Low Energy (BLE) channels, and where the second channel is overlapped by a Wi-Fi channel.

Example 35. The method of one of examples 31 to 34, further including: in response to determining that the second energy measurement is above a second threshold, continuing to receive the signals according to the first communication protocol without tuning the transceiver to a third channel.

Example 36. The method of one of examples 31 to 35, where the second channel is associated with the second communication protocol and has a second center frequency and a second bandwidth, and where the first channel and the second channel do not overlap.

Corresponding numerals and symbols in the different figures generally refer to corresponding parts, unless otherwise indicated. The figures are not necessarily drawn to scale. In the drawings, like reference numerals refer to like elements throughout, and the various features are not necessarily drawn to scale.

The term “semiconductor package” is used herein. A semiconductor package has at least one semiconductor die electrically coupled to terminals and has a package body that protects and covers the semiconductor die. In some arrangements, multiple semiconductor dies can be packaged together. The semiconductor die may be mounted with a package substrate that provides conductive leads. A portion of the conductive leads form the terminals for the packaged device. In wire bonded integrated circuit packages, bond wires couple conductive leads of a package substrate to bond pads on the semiconductor die. The semiconductor die can be mounted to the package substrate with a device side surface facing away from the substrate and a backside surface facing and mounted to a die pad of the package substrate. The semiconductor package can have a package body formed by a thermoset epoxy resin mold compound in a molding process, or by the use of epoxy, plastics, or resins that are liquid at room temperature and are subsequently cured. The package body may provide a hermetic package for the packaged device. The package body may be formed in a mold using an encapsulation process, however, a portion of the leads of the package substrate are not covered during encapsulation, these exposed lead portions form the terminals for the semiconductor package. The semiconductor package may also be referred to as a “integrated circuit package,” a “microelectronic device package,” or a “semiconductor device package.”

While various examples of the present disclosure have been described above, it should be understood that they have been presented by way of example only and not limitation. Numerous changes to the disclosed examples can be made in accordance with the disclosure herein without departing from the spirit or scope of the disclosure. Modifications are possible in the described embodiments, and other embodiments are possible, within the scope of the claims. Thus, the breadth and scope of the present invention should not be limited by any of the examples described above. Rather, the scope of the disclosure should be defined in accordance with the following claims and their equivalents.

What is claimed is:

1. An electronic device comprising:
a transceiver; and
a processor configured to:
receive signals via the transceiver;
decode the signals according to a first communication protocol and on a first channel having a first center frequency and a first bandwidth;
perform an energy detection operation on a second channel and on a third channel, wherein the second channel has a second center frequency and a second bandwidth, and wherein the third channel has a third center frequency and a third bandwidth; and
determine that energy detected on the second channel corresponds to a second communication protocol based on the energy detection operation.

2. The electronic device of claim 1, wherein the processor is configured to determine that the energy detected on the second channel corresponds to the second communication protocol by determining that the energy detected on the second channel is above a first threshold and by determining that energy detected on the third channel is below a second threshold.

3. The electronic device of claim 1, wherein the second channel corresponds to a first advertising channel, and wherein the third channel corresponds to a first data channel.

4. The electronic device of claim 1, wherein the processor is further configured to, in response to determining that energy detected on the second channel corresponds to the second communication protocol:
stop decoding the signals according to the first communication protocol;
receive, via the transceiver, further signals on a fourth channel that is associated with the second communication protocol, wherein the fourth channel has a fourth center frequency and a fourth bandwidth; and
decode the further signals according to the second communication protocol.

5. The electronic device of claim 4, wherein the fourth bandwidth and the second bandwidth are equal, and wherein the second center frequency and the fourth center frequency are different.

6. The electronic device of claim 1, wherein the processor is further configured to, in response to determining that energy detected on the second channel corresponds to the second communication protocol:
stop decoding the signals according to the first communication protocol; and
reconfigure a physical layer of the transceiver to receive and decode further signals on a fourth channel having a fourth center frequency and a fourth bandwidth.

7. The electronic device of claim 1, wherein the processor is further configured to, in response to determining that energy detected on the second channel corresponds to the second communication protocol:
stop decoding the signals according to the first communication protocol; and
receive, via the transceiver, and decode further signals according to a third communication protocol and on a fourth channel that partially or fully overlaps with the third channel.

8. The electronic device of claim 7, wherein the fourth channel has a fourth bandwidth that is bigger than the third bandwidth.

9. The electronic device of claim 1, wherein the second channel corresponds to Bluetooth Low Energy (BLE) channel 37, and wherein the third channel corresponds to BLE channel 0.

10. The electronic device of claim 1, wherein the third channel is overlapped by Wi-Fi channel 1.

11. The electronic device of claim 1, wherein to perform the energy detection operation, the processor is configured to generate a received signal strength indicator (RSSI) for the second channel and the third channel.

12. The electronic device of claim 11, wherein the processor is configured to determine that the energy detected on the second channel corresponds to the second communication protocol by determining that the RSSI for the second channel is above a first threshold and by determining that the RSSI for the third channel is below a second threshold.

13. The electronic device of claim 1, wherein the second channel and the third channel do not overlap.

14. The electronic device of claim 1, wherein to determine that energy detected on the second channel corresponds to a second communication protocol, the processor is configured to determine that a fourth channel, associated with a third communication protocol and that overlaps with the third channel, is not busy with further signals associated with the third communication protocol.

15. The electronic device of claim 1, wherein the second channel and the third channel are adjacent according to the second communication protocol.

16. The electronic device of claim 1, wherein the second channel and the third channel are separated by at least one further channel according to the second communication protocol.

17. The electronic device of claim 1, wherein the second bandwidth and the third bandwidth are equal, and wherein the second center frequency and the third center frequency are different.

18. The electronic device of claim 1, wherein the first communication protocol is an IEEE 802.15.4-based communication protocol.

19. The electronic device of claim 18, wherein the first communication protocol is a Zigbee protocol and the second communication protocol is a Bluetooth Low Energy (BLE) protocol.

20. The electronic device of claim 1, wherein the processor is configured to perform the energy detection operation on the second channel, and the energy detection operation on the third channel, sequentially.

21. The electronic device of claim 1, wherein the processor is configured to perform the energy detection operation on the second channel, and the energy detection operation on the third channel, in parallel.
